(19) United States
(12) Patent Application Publication
(10) Pub. No.: US 2013/0128048 A1
(43) Pub. Date: May 23, 2013

(54) IMAGING SYSTEM AND IMAGING DEVICE

(71) Applicant: Sony Corporation, Tokyo (JP)

(72) Inventor: Hiroaki Okajima, Chiba (JP)

(73) Assignee: SONY CORPORATION, Tokyo (JP)

(21) Appl. No.: 13/675,108

(22) Filed: Nov. 13, 2012

(30) Foreign Application Priority Data
Nov. 21, 2011 (JP) 2011-253856

(51) Int. Cl. B60R 1/00

(52) U.S. Cl. CPC B60R 1/00
USPC 348/148

(57) ABSTRACT

Disclosed herein is an imaging system including: an imaging section attached to a bottom of a vehicle to capture an omnidirectional image; and a display section adapted to display the omnidirectional image captured by the imaging section

### BACKGROUND

The present disclosure relates to an imaging system and imaging device applied, for example, to a vehicle.

A system has been proposed to install a plurality of imaging devices around a car or work vehicle and display images captured by the plurality of imaging devices to a driver (refer to Japanese Patent Laid-Open No. 2000-197039 and Japanese Patent Laid-Open No. 2004-297405). Such a system allows the driver to check whether there is any person or obstacle around the car.

### SUMMARY

With related art, it has been necessary to provide a plurality of imaging devices and wirings configured to connect the plurality of imaging devices, thus resulting in increased cost. Further, it has been necessary to adjust the position of each of the imaging devices with high accuracy so as to combine the images captured by the plurality of imaging devices seamlessly. Still further, the imaging devices are installed on the surface of the car. Therefore, it is difficult to capture an image of the bottom of the car and the surrounding area, for example. In a case of a vehicle with an elevated height such as an SUV (Sport Utility Vehicle), truck or bus, a dangerous situation may arise due to presence of an infant, small animal or obstacle around the bottom of the vehicle. However, it is difficult to show the condition around the bottom of the vehicle to the driver, thus making it difficult for the driver to recognize these dangerous conditions.

Therefore, it is desirable to provide an imaging system and imaging device configured to show the condition around the bottom of the vehicle to the driver.

According to an embodiment of the present disclosure, there is provided an imaging system that includes an imaging section and display section. The imaging section is attached to a bottom of a vehicle to capture an omnidirectional image. The display section displays the omnidirectional image captured by the imaging section.

According to the embodiment of the present disclosure, there is also provided an imaging device that includes an omnidirectional imaging section attached to a bottom of a vehicle. The omnidirectional imaging section is covered with a protective member in a non-imaging state and exposed from the protective member in an imaging state.

At least one embodiment makes it possible to show the condition around the bottom of the vehicle to the driver.

### BRIEF DESCRIPTION OF THE DRAWINGS

FIG. 1 is a block diagram illustrating an example of an imaging system;

FIG. 2 is an outlined diagram describing an example of a position where an imaging device is attached;

FIG. 3 is an outlined diagram describing a configuration example of areas around an imaging section;

FIGS. 4A and 4B are outlined diagrams describing an example of a non-imaging state and an example of an imaging state;

FIG. 5 is a diagram describing an example of a forward image;

FIG. 6 is a diagram describing an example of a rearward image;

FIG. 7 is a diagram describing an example of a right side image;

FIG. 8 is a diagram describing an example of a left side image;

FIG. 9 is a diagram illustrating an example of a manner in which a plurality of images are displayed;

FIG. 10 is a diagram illustrating another example of the manner in which a plurality of images are displayed;

FIG. 11 is a diagram illustrating still another example of the manner in which a plurality of images are displayed; and

FIG. 12 is a flowchart illustrating an example of process flow.

### DETAILED DESCRIPTION OF THE PREFERRED EMBODIMENT

A description will be given below of an embodiment of the present disclosure with reference to the accompanying drawings. It should be noted that the description will be given in a following order.
<1. Embodiment>
<2. Modification Example>

It should be noted that the embodiment and modification example described below are a preferred specific example of the present disclosure, and that the present disclosure is not limited to the embodiment and modification example.

### 1. EMBODIMENT

### [Configuration of Imaging System]

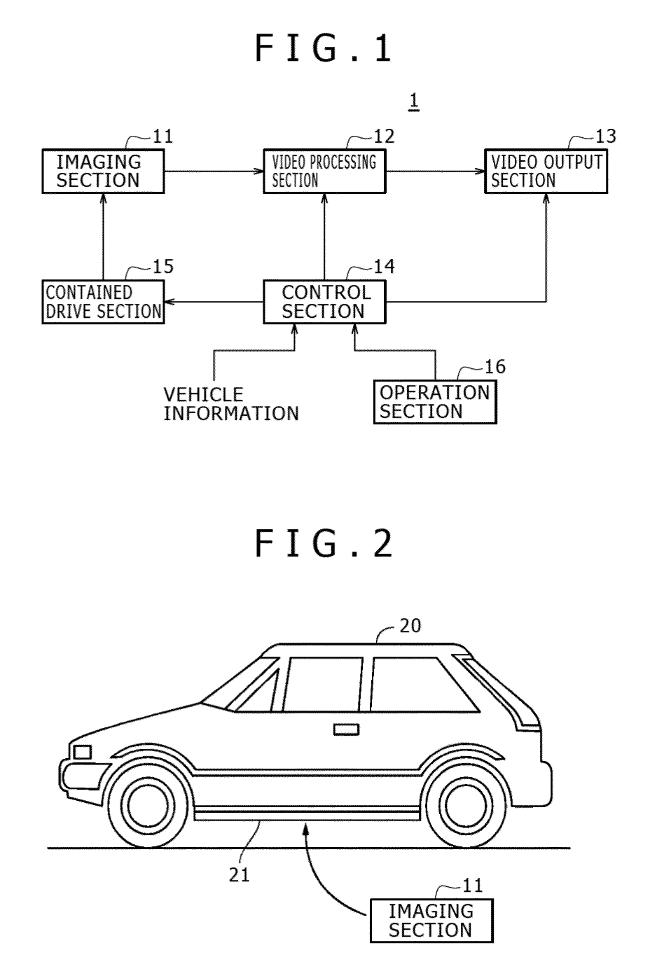

FIG. 1 illustrates a configuration example of an imaging system. The imaging system shown in FIG. 1 is mounted, for example, to a vehicle. An imaging system 1 includes an imaging section 11, video processing section 12, video output section 13, control section 14, contained drive section 15 and operation section 16.

The imaging section 11 includes, for example, an imaging optics such as a lens, an imaging element such as CCD (Charge Coupled Device) or CMOS (Complementary Metal Oxide Semiconductor) and a drive system adapted to drive the lens and imaging element. The imaging optics taken as an example in the present disclosure is an omnidirectional imaging optics adapted to capture an image of subjects existing in all directions (0 to 360 degrees) of the imaging section 11. Well-known components can be used to make up the omnidirectional imaging optics. The omnidirectional imaging optics captures an image of areas, in all directions of the imaging section 11, around the vehicle. For example, the same optics captures an image of the bottom of the vehicle and a surrounding area. It should be noted that term “the bottom of the vehicle and a surrounding area” refers to a space between the bottom of the vehicle and the road surface and a space in the vicinity of that space.

Imaging by the imaging section 11 provides an imaging signal in ring shape (hereinafter referred to as annular imaging signal as appropriate). A timing signal generated under control of the control section 14 is supplied to the drive system. The drive system operates in response to the timing signal to drive the lens, imaging element, and the like.

The video processing section 12 includes an analog signal processing block, A/D (Analog to Digital) conversion block and digital signal processing block. The analog signal processing block performs CDS (Correlated Double Sampling) on the annular imaging signal supplied from the imaging element, thus providing improved S/N ratio (Signal to Noise Ratio). The analog signal processing block also performs AGC (Automatic Gain Control) on the signal, thus controlling the gain. The annular imaging signal that has been subjected to analog signal processing is converted to a digital signal by the A/D conversion block. The digital annular imaging signal is supplied to the digital signal processing block.

The digital signal processing block subjects the annular imaging data to demosaicing and other camera signal processing such as AF (Auto Focus), AE (Auto Exposure) and AWB (Auto White Balance). Further, the digital signal processing block works on the annular imaging data, thus generating a piece of belt-shaped imaging data and dividing the generated imaging data. Dividing the belt-shaped imaging data generates forward, rearward, right side and left side imaging data. These pieces of generated imaging data in different directions are supplied to the video output section 13. It should be noted that each direction is defined assuming that the front side of the car is forward. However, these directions are determined in consideration of convenience of explanation. Therefore, the content of the present disclosure is not limited to these directions.

The video output section 13, an example of a display section, has a display panel such as LCD (Liquid Crystal Display) or organic EL (Electroluminescence) panel and a drive circuit appropriate for the display panel. The same section 13 is disposed, for example, approximately at the center of a dashboard of the vehicle. The imaging data in each direction supplied from the video processing section 12 is subjected to given processing by the drive circuit. The processed imaging data is played on the display panel. This allows the driver to check the image appearing on the display panel.

It should be noted that other images or information may be displayed on the video output section 13. For example, the video output section 13 may display a digital television broadcasting image or map information of a navigation system. Further, the display panel of the video output section 13 may be a touch panel so that functions of the operation section 16 which will be described later are available on the video output section 13.

The control section 14 includes, for example, a CPU (Central Processing Unit) to control each section of the imaging system 1. The control section 14 exercises control including setting given parameters to the video processing section 12 and video output section 13, specifying timings at which to start and terminate processing and supplying power to those sections in need of power. Further, the control section causes the imaging section 11 to start and terminate imaging.

Vehicle information is supplied to the control section 14. Each section of the vehicle is connected, for example, to a CAN (Controller Area Network) bus, thus allowing these sections to communicate according to the CAN standard. Vehicle information is, for example, information about vehicle speed and information indicating an anomaly of the vehicle. The control section 14 exercises control according to the vehicle information in such a manner as to operate instruments of the vehicle and notify an anomaly to the driver.

The contained drive section 15 incorporates a motor and is, for example, cylindrical in form. The same section 15 moves in a manner similar to a motor-operated zoom mechanism of an ordinary imaging device. The rotating speed of the motor of the contained drive section 15, for example, is controlled by the control section 14. The imaging section 11 described above is attached to the contained drive section 15. The same section 15 drives the imaging section 11 from a non-imaging into imaging state or vice versa. The term “non-imaging state” refers to a state in which the imaging section is, for example, covered with a protective member. The term “imaging state” refers to a state in which the imaging section 11 is, for example, exposed from the protective member. These states will be described in detail later.

The operation section 16 is a general term for those that can be operated to act on the vehicle. This includes a door and a gear lever provided on the vehicle, operation units of the vehicle such as a headlight and a lamp, and a switch provided on audio equipment. An operation signal appropriate to the operation performed on the operation section 16 is generated and supplied to the control section 14. The control section 14 exercises control according to the supplied operation signal.

### [Attachment Position of Imaging Section]

FIG. 2 shows an example of a position where the imaging section 11 is attached. The same section 11 is attached approximately at the center of a bottom 21 of a vehicle 20, for example. The imaging section 11 may be attached to other position of the bottom 21 such as closer to the front or rear. It should be noted that the vehicle 20 may be not only a vehicle used by a common user but also a bus, truck or work vehicle. Further, the present embodiment is also widely applicable to a train, airplane or other vehicle that moves on wheels.

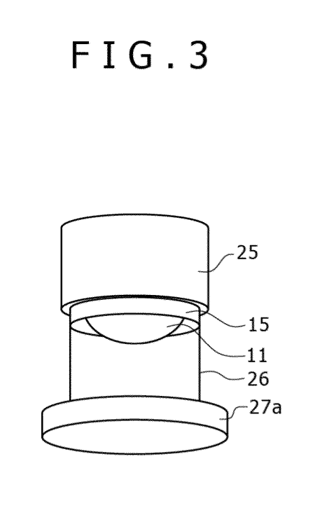

FIG. 3 illustrates a configuration example of areas around the imaging section 11. A hollow cylindrical support is provided inside the vehicle 20. The contained drive section 15 is free to rise or lower vertically (in a direction approximately orthogonal to the bottom 21) inside the support 25. The imaging section 11 is provided on an end surface of the contained drive section 15. The imaging section 11 is surrounded by a cylindrical transparent member 26. The same member 26 is made, for example, of glass. A disc-shaped lid body 27a is formed on an end portion of the transparent member 26.

### [Non-Imaging State and Imaging State]

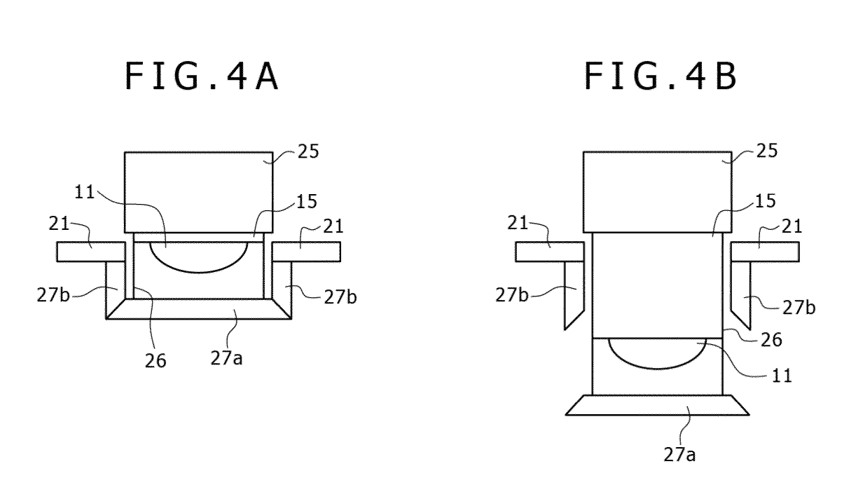

FIG. 4A illustrates an example of the non-imaging state. A cylindrical side plate 27b is implanted vertically on the bottom 21 to extend downward. The above lid body 27a can be attached to an end surface of the side plate 27b. When the imaging section 11 is switched into the non-imaging state, the contained drive section 15 rises. Then, when the lid body 27a fits onto the side plate 27b, the contained drive section 15 stops.

A concave containment space is formed inside the vehicle 20 by the lid body 27a and side plate 27b. In the non-imaging state, the imaging section 11 is contained in the containment space and covered with the lid body 27a and side plate 27b. That is, the lid body 27a and side plate 27b serve as protective members for the imaging section 11. The lid body 27a and side plate 27b are made of a solid material such as steel. The side plate 27b is, for example, about several to ten centimeters in height (length in the direction approximately orthogonal to the bottom 21) to ensure that the same plate 27b does not cause hindrance to cruising.

FIG. 4B illustrates an example of the imaging state. This state includes a state in which imaging is actually performed. When the imaging section 11 is switched into the imaging state, the contained drive section 15 begins to lower. The same section 15 lowers through an opposed space between the bottom 21 and road surface and stops at a given position. As the contained drive section 15 lowers, the imaging section 11 is exposed from the containment space formed by the protective members. When the contained drive section 15 stops, the imaging section 11 is placed in the opposed space between the bottom 21 and road surface. In the imaging state, the imaging section 11 captures an omnidirectional image of the bottom and the surrounding area.

When the vehicle 20 is in a cruising preparation state, the imaging section 11 is switched from the non-imaging to imaging state. The term “cruising preparation state” refers, for example, to a state in which the driver performs an operation to open the door, makes a movement to seat himself or herself on a driver's seat, and performs an operation to start an engine. The contained drive section 15 lowers in response to the operations performed and movement made in the cruising preparation state as triggers and stops at a given position. As a result, the imaging section 11 is placed in the opposed space between the bottom 21 and road surface, thus switching the same section 11 into the imaging state.

If, for example, a startup operation is performed on the vehicle 20, the imaging section 11 is switched from the imaging to non-imaging state. The startup operation is designed to start up the vehicle 20 and includes, for example, an operation to move the gear lever to a drive position and an operation to step on an accelerator. The startup operation may include an operation such as pressing a check button performed by the driver after he or she has checked the safety of the bottom of the vehicle. Further, after the vehicle 20 begins to cruise, the imaging section 11 may be switched from the imaging to non-imaging state.

### [Example of Image]

When in the imaging state, the imaging section 11 captures an image of the bottom of the vehicle and the surrounding area and generates an annular imaging signal. The video processing section 12 processes the annular imaging signal, thus generating forward, rearward, right side and left side imaging data. Then, images based on the imaging data are displayed on the video output section 13. Naturally, the annular imaging signal may be divided into a different number of images rather than four images such as forward image.

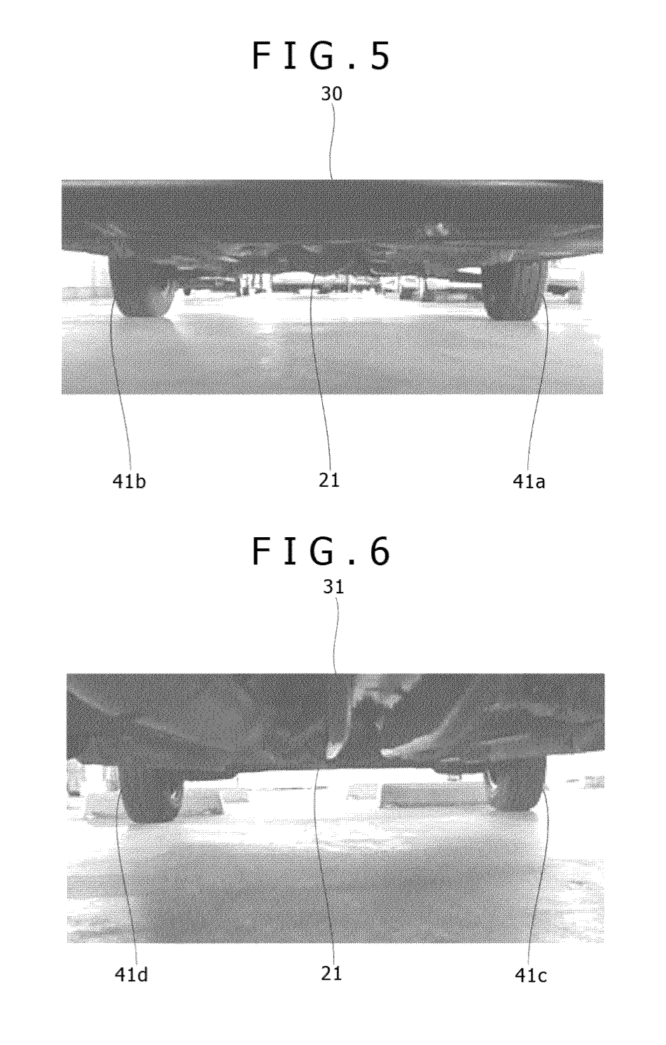

FIG. 5 illustrates an example of a forward image. A forward image 30 displays the forward bottom 21, the road surface opposed to the forward bottom 21, a forward right side tire 41a, a forward left side tire 41b and so on. FIG. 6 illustrates an example of a rearward image. A rearward image 31 displays the rearward bottom 21, the road surface opposed to the rearward bottom 21, a rearward left side tire 41c (displayed at right in FIG. 6), a rearward right side tire 41d (displayed at left in FIG. 6) and so on.

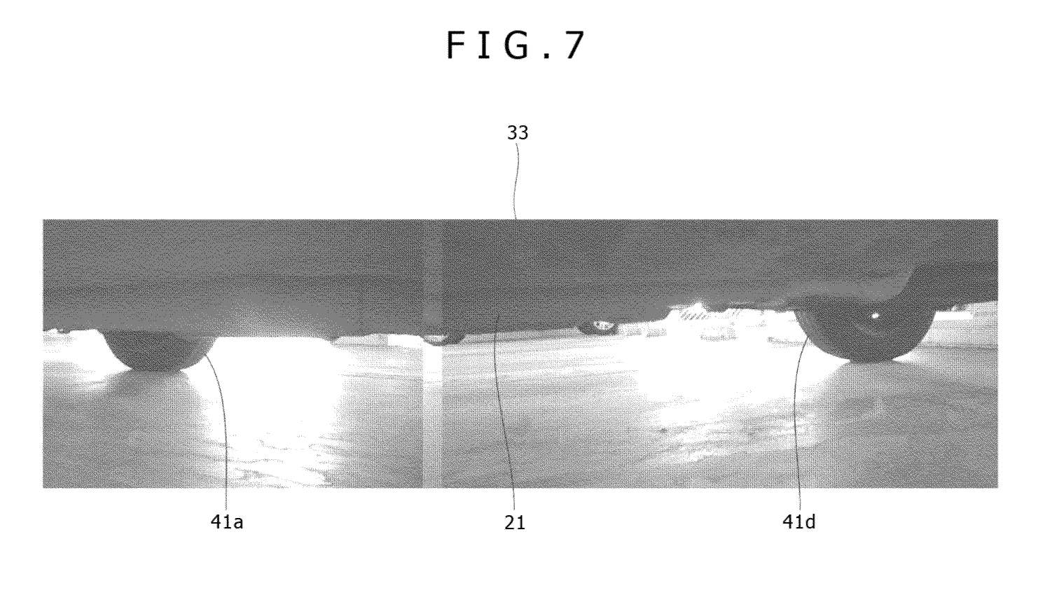

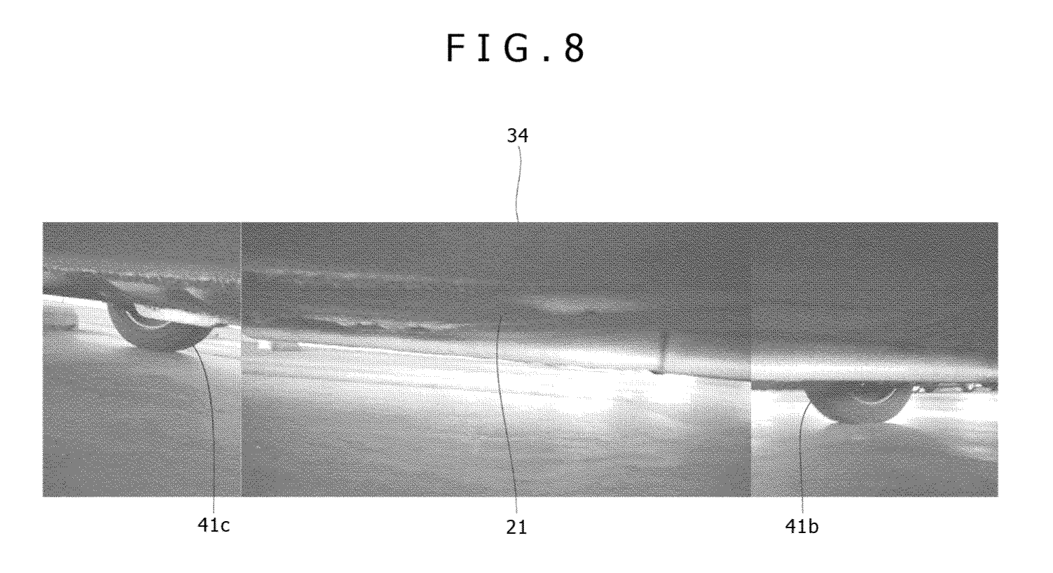

FIG. 7 illustrates an example of a right side image. A right side image 33 displays the right side bottom 21, the road surface opposed to the right side bottom 21, the forward right side tire 41a, rearward right side tire 41d and so on. FIG. 8 illustrates an example of a left side image. A left side image 34 displays the left side bottom 21, the road surface opposed to the left side bottom 21, the forward left side tire 41b, rearward left side tire 41c and so on.

The driver can check whether there is any infant, small animal or obstacle such as a movable tire stopper in a parking lot between the bottom 21 and road surface by checking these images. The driver can start cruising after going through the above process, thus ensuring safety in cruising. Further, this prevents possible collisions of the bottom or tire with an obstacle, thus preventing damage. It should be noted that there is a dead angle in an extension direction of each of the tires from the imaging section 11. However, there is no likelihood that the vehicle will start cruising toward areas at dead angles. Therefore, no problems will arise.

### [Example of Display Method]

A description will be given next of an example of an image display method. A possible method would be to display an image in each direction one at a time in sequence. For example, the displayed image is switched in sequence from the forward image to the right side image, and then to the rearward image, and then to the left side image. Naturally, the displayed image can be switched in this manner. However, a short amount of time is necessary from when the first forward image is displayed to when the last left side image is displayed. Therefore, although it is rare, there is a likelihood that an infant or small animal, for example, may sneak under the forward bottom while this small amount of time elapses.

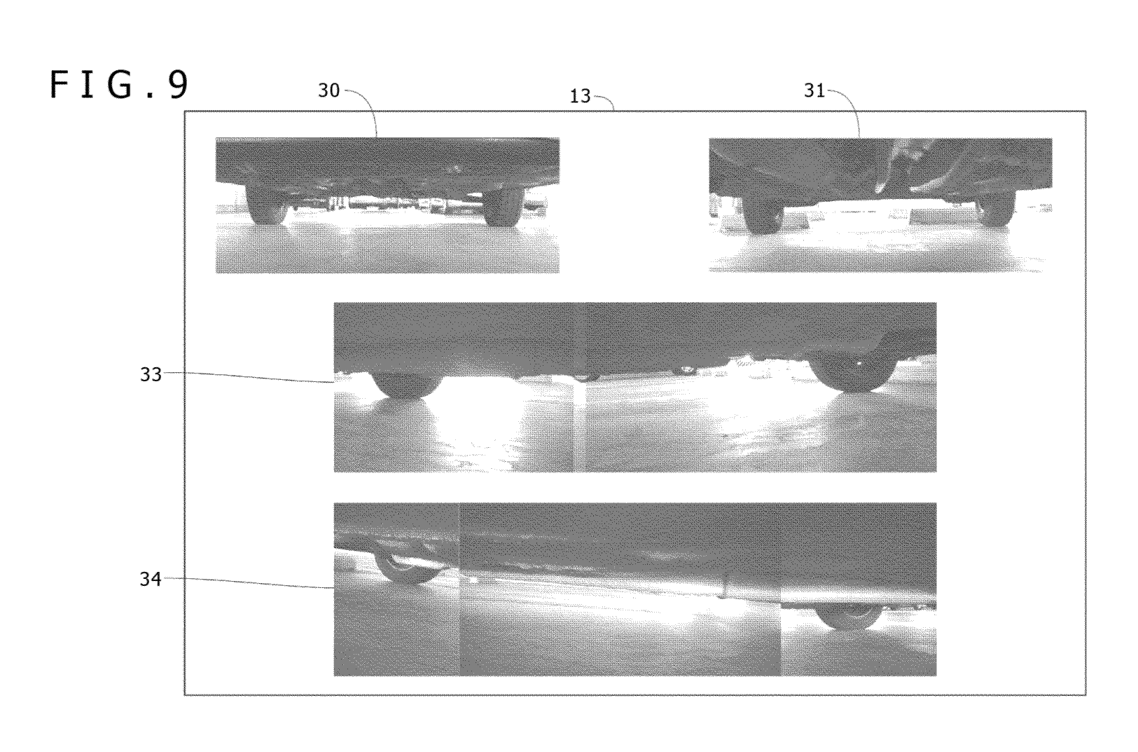

In the embodiment of the present disclosure, the images in all directions are displayed approximately at the same time as an example in consideration of the above. FIG. 9 illustrates an example of a manner in which images are displayed in the present embodiment. The video output section 13 is divided into given areas, and the images 30, 31, 33 and 34 are displayed respectively in these areas approximately at the same time. Displaying the images in this manner makes it possible for the driver to check the condition around the bottom of the vehicle in real time.

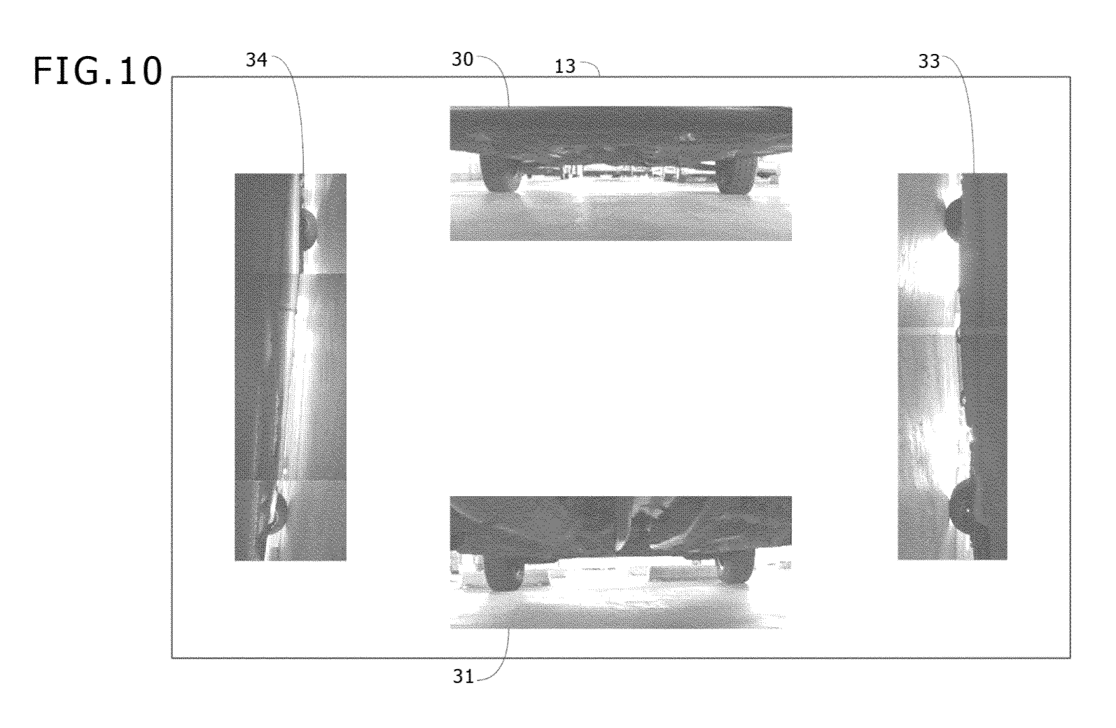

It should be noted that it is possible to change, as appropriate, which image is to be displayed in which area of the video output section 13. For example, a plurality of images may be displayed in a divided manner to match forward, rearward, right side and left side of the vehicle. As illustrated in FIG. 10, the forward image 30 may be displayed somewhat at the top of the video output section 13, the rearward image 31 somewhat at the bottom thereof, the right side image 33 somewhat at the right thereof, and the left side image 34 somewhat at the left thereof, relative to the driver. Thus, displaying a plurality of images makes it possible for the driver to intuitively recognize all directions of the bottom of the vehicle.

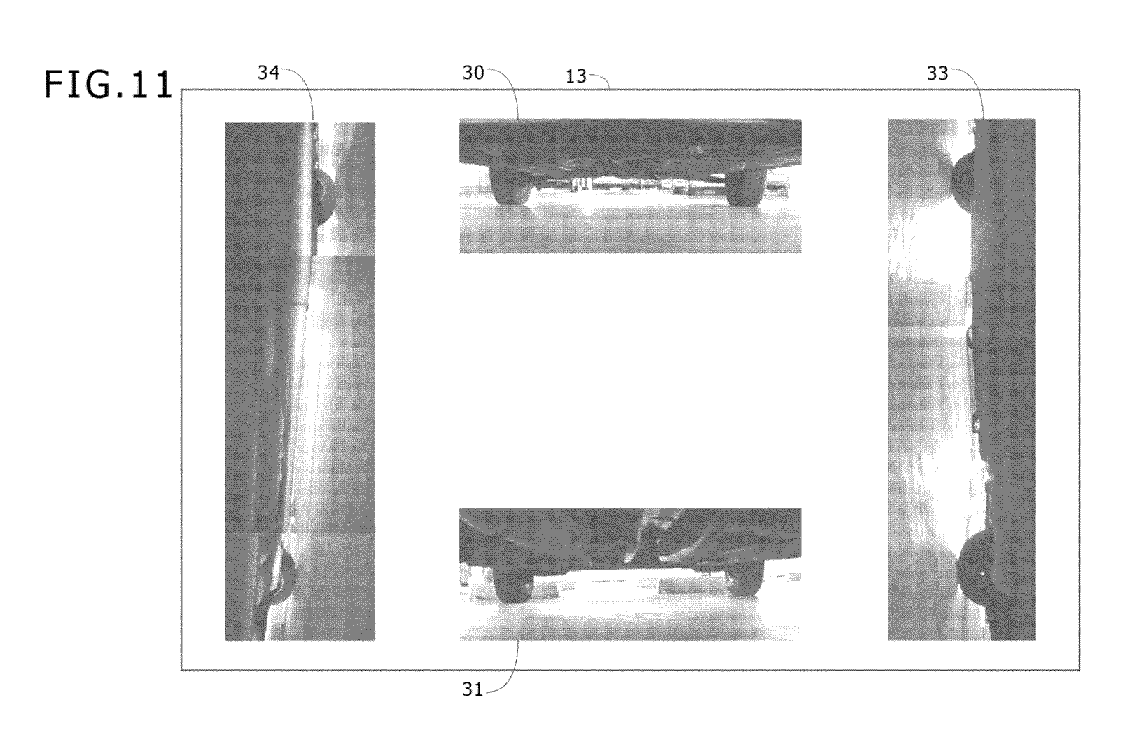

As illustrated in FIG. 11, the images 30 and 31 may be displayed between the images 33 and 34. Displaying the plurality of images in this manner makes it possible for the driver to not only intuitively recognize all directions of the bottom of the vehicle but also effectively make use of the display area of the video output section 13. Further, it is possible to display, in an enlarged manner, the images 33 and 34 that span large areas to be checked by the driver. An icon representing the driver may be displayed at the center of the video output section 13 in FIG. 11.

The imaging section 11 has the omnidirectional imaging optics. This makes it possible to capture an image of all directions at the same time without using a plurality of imaging devices. Because it is not necessary to use a plurality of imaging devices, it is possible to reduce cost. Further, this prevents the system configuration from becoming complicated as a result of increase in number of wirings.

### [Process Flow]

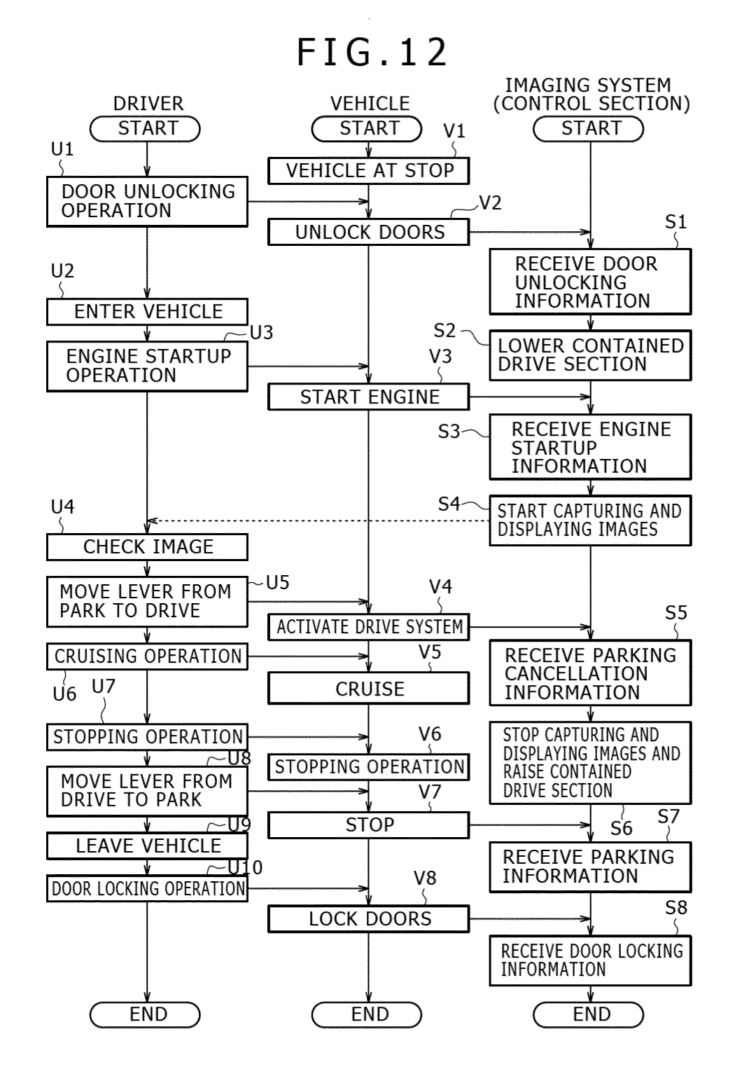

FIG. 12 is a flowchart illustrating an example of a process flow in the embodiment of the present disclosure. In FIG. 12, a flow on the left shows operations performed by the driver (user). A flow in the center shows actions performed by the vehicle. A flow on the right shows actions performed by the system (mainly control exercised by the control section 14) in response to the actions of the vehicle.

The process begins. When the process begins, the vehicle 20 is at stop (step V1). When the vehicle 20 is at stop, the imaging section 11 is in the non-imaging state. In step U1, the driver performs an operation adapted to unlock the doors of the vehicle 20. In response to this operation, the doors of the vehicle 20 are unlocked in step V2. Then, in step S1, the control section 14 receives a door unlocking signal indicating the unlocking of the doors. The control section 14 can recognize that the driver will soon enter and start up the vehicle 20. Then, the process proceeds to step S2.

In step S2, the control section 14 that has received the door unlocking signal exercises control in such a manner as to lower the contained drive section 15. In response to this control, the contained drive section 15 lowers and stops at a given position. When the same section stops, the imaging section 11 is placed in the opposed space between the bottom 21 and road surface.

The driver who has unlocked the doors enters the vehicle 20 in step U2. Then, the process proceeds to step U3 where the user performs an operation to start up the engine. In response to this operation, the engine of the vehicle 20 starts up in step V3. In step S3, a startup signal indicating the startup of the engine is supplied to the control section 14. The control section 14 causes the imaging section 11 to start capturing an image in response to the supplied startup signal. Then, the process proceeds to step S4. In step S4, the imaging section 11 starts to capture an image. Then, the video processing section 12 subjects an imaging signal to given processing, as a result of which the images of the bottom of the vehicle and the surrounding area are displayed on the video output section 13 as illustrated, for example, in FIG. 9.

In step U4, the driver checks the images of the bottom of the vehicle and the surrounding area displayed on the video output section 13. Then, the driver checks whether there is any child or obstacle under the bottom of the vehicle and in the surrounding area. If there is a child or obstacle, the driver takes the child away from the vehicle to a safe area or removes the obstacle. When the driver checks the safety of the bottom of the vehicle with no child or obstacle around, the process proceeds to step U5. In step U5, the driver performs a startup operation to move the gear lever from the park to drive position. In response to the startup operation, the drive system of the vehicle 20 is activated in step V4. In step S5, the control section 14 receives a parking cancellation signal indicating that the parking has been cancelled. Then, the process proceeds to step S6.

In step S6, the control section 14 causes the imaging section 11 to stop capturing an image. Then, the control section 14 causes the contained drive section 15 to rise. The same section 15 rises and stops at a given position. The imaging section 11 is covered by the protective members, thus switching the same section 11 into the non-imaging state.

In step U6, the driver performs operations including stepping on the accelerator. In response to these operations, the vehicle 20 begins to cruise in step V5. When the vehicle 20 cruises, the imaging section 11 is covered with the protective members. This protects the imaging section 11 from staining and damage even if mud and stones are kicked up during the cruising of the vehicle 20.

When the cruising stops, the driver performs a stopping operation in step U7. This operation is designed, for example, to park the vehicle 20 in a parking lot. In step V6, the vehicle 20 moves in response to the stopping operation. In step U8, the stopping operation ends, and the driver moves the gear lever from the drive to park position. In response to the operation of the gear lever, the tires of the vehicle 20 are locked, thus stopping the vehicle 20. In step S7, the control section 14 receives a signal indicating that the gear lever has been moved to the park position.

Then, the user performs operations including stopping the engine. In step U9, the user leaves the vehicle 20. The process proceeds to step U10 where the driver performs a door locking operation. In response to the door locking operation, the doors of the vehicle 20 are locked in step V8. In step S8, the control section 14 receives a signal indicating that the doors have been locked. The series of process steps end as described above.

### 2. MODIFICATION EXAMPLE

Although a description has been given of an embodiment of the present disclosure, the present disclosure is not limited to the above embodiment but may be modified in various ways. A description will be given below of a modification example.

It has been described in the above embodiment that the imaging section 11 is displaced in response to the ascent or descent of the contained drive section 15 so that the imaging section 11 is exposed from the protective members. However, the imaging section 11 may be fixed in position. Then, the protective members protecting the imaging section 11 may be displaced as appropriate so that the imaging section 11 is exposed from the protective members.

It has been described in the above embodiment that the imaging section 11 is exposed from the protective members after the doors are unlocked. However, the imaging section 11 may be exposed from the protective members, for example, in response to the fact that the driver seats himself or herself in the driver's seat. The fact that the driver seats himself or herself in the driver's seat can be detected, for example, by a pressure sensor. The imaging section 11 may be exposed from the protective members in response to the engine startup operation. However, it is preferred that the contained drive section 15 should lower to place the imaging section 11 in the space between the vehicle bottom 21 and road surface before the engine starts up in consideration of the amount of time necessary to lower the contained drive section 15 and process the video signal.

It has been described in the above embodiment that the imaging section 11 stops capturing images and is covered with the protective members when the gear lever is moved from the park to drive position. However, the timing at which the imaging section 11 stops capturing an image, for example, can be changed as appropriate. For example, the imaging section may stop capturing an image and be contained when the vehicle speed reaches a given level (e.g., 5 km/h). This allows the driver to check the condition around the bottom of the vehicle at and immediately after the startup of the vehicle 20.

Images of the bottom of the vehicle and the surrounding area may be displayed when the gear lever is moved to a reverse position. This allows the driver to check the condition under the bottom of the vehicle and in the surrounding area first and then move the vehicle backward into a parking lot, thus ensuring safety.

The imaging section 11 may have infrared detection capability. This capability permits detection of infrared radiation energy emitted from a child or small animal. An area corresponding to the detected infrared radiation energy may be highlighted on the video output section 13. In particular, there is a case in which it is difficult to visually identify a child or the like in images during nighttime when it is dark under the bottom of the vehicle and in the surrounding area. Even in such a case, the area corresponding to the heat-generating object is highlighted, thus making it possible to identify the presence of a child or small animal under the bottom of the vehicle and in the surrounding area.

It should be noted that two imaging sections, one normal and another having infrared detection capability, may be switched during daytime and nighttime. A luminance sensor may be provided so that the two imaging sections, one normal and another having infrared detection capability, are switched according to the luminance level obtained by the luminance sensor.

An auxiliary lamp may be provided on the bottom 21 of the vehicle 20 to illuminate the area immediately under the bottom 21 of the vehicle 20. The auxiliary lamp may be lit up when the imaging section 11 is in the imaging state. The area immediately under the bottom 21 of the vehicle 20 is shadowed by the vehicle body, thus making this area dark. Lighting up the auxiliary lamp provides sufficient luminance for image capture, thus making it possible to capture sharp images. The imaging section 11 and auxiliary lamp may be driven by the contained drive section 15 and contained in the containment space. Then, the imaging section 11 and auxiliary lamp may be covered with the protective members.

The video processing section 12 may handle detection. For example, the same section 12 handles skin color detection. An area in which skin color has been detected may be highlighted on the video output section 13. This allows the driver to identify the presence of a child or infant under the bottom 21 of the vehicle 20 and in the surrounding area. Further, shapes of typical obstacles present under the bottom 21 of the vehicle 20 may be stored as patterns, thus detecting obstacles through pattern matching.

The driver may be notified by voice or alarm sound. For example, a message “Please check under the vehicle on the images.” may be played when the images of the bottom 21 of the vehicle 20 and the surrounding area are displayed. Further, if a child or obstacle is detected by the above infrared detection capability or detection process, a message “A child or obstacle may be under your car. Please check.” may be played. Playing such a message prevents the driver from overlooking the presence of a child or obstacle on the images and starting the vehicle 20 by mistake. Still further, if it is determined through a video recognition process that there is, for example, an obstacle under the bottom 21 of the vehicle 20 without displaying any images of the bottom 21 of the vehicle 20, only an alarm sound or message may be played. This contributes to reduced burden on the driver in terms of checking.

A check button may be displayed on the video output section 13 if a child or obstacle is detected by the above infrared detection capability or detection process. Alternatively, it may be difficult to start the vehicle 20 and move it forward or backward unless the driver checks under the vehicle 20 and presses the check button on the video output section 13. Restricting the vehicle movement provides further improved safety.

It should be noted that the configurations and processes of the above embodiment and modification example can be combined as appropriate insofar as no technical contradiction arises. For example, the auxiliary lamp may be provided. In addition thereto, the detection process may be performed, and a message may be played. The sequence of the steps of each of the process flows exemplified above can be changed as appropriate insofar as no technical contradiction arises.

The present disclosure may have following configurations.

(1) An imaging system including:

an imaging section attached to a bottom of a vehicle to capture an omnidirectional image; and

a display section adapted to display the omnidirectional image captured by the imaging section.

(2) The imaging system of paragraph (1), in which the imaging section is covered with a protective member in a non-imaging state and exposed from the protective member in an imaging state.

(3) The imaging system of paragraph (1) or (2), in which

when the vehicle is in a cruising preparation state, the imaging section is switched from the non-imaging to imaging state.

(4) The imaging system of any one of paragraphs (1) to (3), in which

after a startup operation is performed on the vehicle, the imaging section is switched from the imaging to non-imaging state.

(5) The imaging system of any one of paragraphs (1) to (3), in which

after the vehicle begins to cruise, the imaging section is switched from the imaging to non-imaging state.

(6) The imaging system of any one of paragraphs (1) to (5), in which

the omnidirectional image is divided into a plurality of images, and

the plurality of images are displayed in a divided manner on the display section.

(7) The imaging system of paragraph (6), in which

the omnidirectional image is divided into a plurality of images to match forward, rearward, right side and left side of the vehicle, and

the plurality of images are displayed in a divided manner on the display section to match the forward, rearward, right side and left side of the vehicle.

(8) An imaging device including:

an omnidirectional imaging section attached to a bottom of a vehicle, in which

the omnidirectional imaging section is covered with a protective member in a non-imaging state and exposed from the protective member in an imaging state.

The present disclosure contains subject matter related to that disclosed in Japanese Priority Patent Application JP 2011-253856 filed in the Japan Patent Office on Nov. 21, 2011, the entire content of which is hereby incorporated by reference.

What is claimed is:

1. An imaging system comprising:
an imaging section attached to a bottom of a vehicle to capture an omnidirectional image; and
a display section adapted to display the omnidirectional image captured by the imaging section.

2. The imaging system of claim 1, wherein
the imaging section is covered with a protective member in a non-imaging state and exposed from the protective member in an imaging state.

3. The imaging system of claim 2, wherein
when the vehicle is in a cruising preparation state, the imaging section is switched from the non-imaging to imaging state.

4. The imaging system of claim 3, wherein
after a startup operation is performed on the vehicle, the imaging section is switched from the imaging to non-imaging state.

5. The imaging system of claim 3, wherein
after the vehicle begins to cruise, the imaging section is switched from the imaging to non-imaging state.

6. The imaging system of claim 1, wherein
the omnidirectional image is divided into a plurality of images, and
the plurality of images are displayed in a divided manner on the display section.

7. The imaging system of claim 6, wherein
the omnidirectional image is divided into a plurality of images to match forward, rearward, right side and left side of the vehicle, and
the plurality of images are displayed in a divided manner on the display section to match the forward, rearward, right side and left side of the vehicle.

8. An imaging device comprising:
an omnidirectional imaging section attached to a bottom of a vehicle, wherein
the omnidirectional imaging section is covered with a protective member in a non-imaging state and exposed from the protective member in an imaging state.
